(19) United States
(12) Patent Application Publication
(10) Pub. No.: US 2026/0188167 A1
(43) Pub. Date: Jul. 2, 2026

(54) METHOD FOR DRIVING DISPLAY PANEL, METHOD FOR DEBUGGING DISPLAY PANEL, AND STORAGE MEDIUM

(71) Applicant: KunShan Go-Visionox Opto-Electronics Co., Ltd, Kunshan (CN)

(72) Inventors: Yongbin YANG, Kunshan (CN); Zheng WANG, Kunshan (CN); Yong LI, Kunshan (CN)

(73) Assignee: KunShan Go-Visionox Opto-Electronics Co., Ltd, Kunshan (CN)

(21) Appl. No.: 19/543,944

(22) Filed: Feb. 19, 2026

Related U.S. Application Data
(63) Continuation of application No. PCT/CN2024/114182, filed on Aug. 23, 2024.

(30) Foreign Application Priority Data
Aug. 29, 2023 (CN) 202311100300.2

(51) Int. Cl. G09G 3/20; G09G 3/00

(52) U.S. Cl. CPC G09G 3/2074; G09G 3/006; G09G 2300/0842; G09G 2300/0861; G09G 2320/0247; G09G 2330/12; G09G 2340/0435

(57) ABSTRACT

A method for driving a display panel, a method for debugging a display panel, and a storage medium. The method for driving a display panel includes acquiring target black insertion ratios corresponding to a display frame, dividing the display frame into display sub-frames that each include a black insertion stage in which the target control signal is at a non-enable level and a light-emitting stage in which the target control signal is at an enable level, and providing the target control signal obtained based on the target black insertion ratios to the display panel. The target black insertion ratios includes black insertion ratios that respectively correspond to the black insertion stages of the plurality of display sub-frames in the display frame, and at least two of the black insertion ratios that correspond to at least two of the black insertion stages are different from each other.

### CROSS-REFERENCE TO RELATED APPLICATIONS

This application is a continuation of International Application No. PCT/CN2024/114182, filed on Aug. 23, 2024, which claims priority to Chinese Patent Application No. 202311100300.2, filed on Aug. 29, 2023, and entitled “METHOD FOR DRIVING DISPLAY PANEL, APPARATUS, AND COMPUTER READABLE STORAGE MEDIUM”, all of which are incorporated herein by reference in their entireties.

### TECHNICAL FIELD

The present disclosure relates to the field of display technology, and particularly to a method for driving a display panel, a method for debugging a display panel, and a storage medium.

### BACKGROUND

With the development of display technology, good screen display and ultra-long standby time have become important indicators to measure the quality of the display screen. To satisfy ultra-long standby time, the power consumption can be reduced by improving the light-emitting efficiency of a light-emitting material. Given the development of materials is difficult and has a lengthy cycle, the power consumption can typically be reduced by lowering the frequency (or referred to as refresh rate) of the display panel.

However, as the frequency of the display panel decreases, a flicker of the display panel becomes more severe.

### SUMMARY

In a first aspect, some embodiments of the present disclosure provide a method adapted for driving a display panel. The display panel is configured to emit light under a control of a target control signal. The method includes: acquiring target black insertion ratios corresponding to a display frame; dividing the display frame into a plurality of display sub-frames, where each of the plurality of display sub-frames comprises a black insertion stage in which the target control signal is at a non-enable level and a light-emitting stage in which the target control signal is at an enable level, the target black insertion ratios comprising black insertion ratios that respectively correspond to the black insertion stages of the plurality of display sub-frames in the display frame, and at least two of the black insertion ratios that correspond to at least two of the black insertion stages being different from each other; and providing the target control signal obtained based on the target black insertion ratios to the display panel.

In a second aspect, some embodiments of the present disclosure provide an apparatus for driving a display panel. The display panel is configured to emit light under a control of a target control signal. The apparatus includes a ratio adjustment recording module, a duty cycle control module, and an output module. The ratio adjustment recording module is configured to acquire target black insertion ratios corresponding to a display frame. The duty cycle control module is configured to divide the display frame into a plurality of display sub-frames. Each of the plurality of display sub-frames comprises a black insertion stage in which the target control signal is at a non-enable level and a light-emitting stage in which the target control signal is at an enable level, the target black insertion ratios comprising black insertion ratios that respectively correspond to the black insertion stages of the plurality of display sub-frames in the display frame, and at least two of the black insertion ratios that correspond to at least two of the black insertion stages being different from each other. The output module is configured to provide the target control signal obtained based on the target black insertion ratios to the display panel.

In a third aspect, some embodiments of the present disclosure provide a display apparatus including an apparatus for driving a display panel according to the embodiments provided in the second aspect.

In a fourth aspect, some embodiments of the present disclosure provide a method for debugging a display panel. The method includes: dividing a preset grayscale range into a plurality of grayscale ranges each including at least two grayscales; acquiring a number of sub-pixels in the display panel; acquiring a plurality of different data volume ranges based on the number of the sub-pixels in the display panel and the plurality of grayscale ranges; and determining black insertion ratios respectively corresponding to the plurality of data volume ranges to obtain a first correspondence relationship.

In a fifth aspect, some embodiments of the present disclosure provide a computer readable storage medium storing a computer program thereon. The computer program, when executed by a processor, implements steps in the method for driving a display panel according to the first aspect, or steps in the method for debugging a display panel according to the third aspect.

### BRIEF DESCRIPTION OF THE DRAWINGS

In order to illustrate technical solutions of embodiments of the present disclosure more clearly, the drawings to be used in the embodiments of the present disclosure will be briefly described below. For a person skilled in the art, other drawings may be obtained from these drawings without any creative efforts.

FIG. 1 is a flow chart of a method for driving a display panel provided by some embodiments of the present disclosure;

FIG. 2 is a schematic structural diagram of a display panel provided by some embodiments of the present disclosure;

FIG. 3 is a schematic structural diagram of a pixel circuit in a display panel provided by some embodiments of the present disclosure;

FIG. 4 is a schematic diagram of a waveform of a target control signal;

FIG. 5 is a schematic diagram of a waveform of an adjusted target control signal;

FIG. 6 is a schematic flow chart of S103 in a method for driving a display panel provided by some embodiments of the present disclosure;

FIG. 7 is a schematic flow chart of S101 in a method for driving a display panel provided by some embodiments of the present disclosure;

FIG. 8 is a schematic flow chart of S401 in a method for driving a display panel provided by some embodiments of the present disclosure;

FIG. 9 is a schematic flow chart of S1031 in a method for driving a display panel provided by some embodiments of the present disclosure;

FIG. 10 is another schematic flow chart of S1031 in a method for driving a display panel provided by some embodiments of the present disclosure;

FIG. 11 is a schematic flow chart of a method for debugging a display panel provided by some embodiments of the present disclosure;

FIG. 12 is a schematic flow chart of S604 in a method for debugging a display panel provided by some embodiments of the present disclosure;

FIG. 13 is a schematic structural diagram of an apparatus for driving a display panel provided by some embodiments of the present disclosure;

FIG. 14 is another schematic structural diagram of an apparatus for driving a display panel provided by some embodiments of the present disclosure; and

FIG. 15 is a hardware schematic diagram of an electronic device provided by some embodiments of the present disclosure.

### DETAILED DESCRIPTION

Features of various aspects and exemplary embodiments of the present disclosure will be described in detail below. In order to make objects, technical solutions, and advantages of the present disclosure clearer, the present disclosure is further described in detail below with reference to the drawings and specific embodiments. It should be understood that the specific embodiments described herein are only intended to explain, rather than to limit, the present disclosure. For those skilled in the art, the present disclosure can be implemented without some of these specific details. The following description of the embodiments is only to provide a better understanding of the present disclosure by illustrating examples of the present disclosure.

It should be noted that, in the present disclosure, the relational terms, such as first and second, are used merely to distinguish one entity or operation from another entity or operation, and do not necessarily require or imply any actual such relationship or order among these entities or operations. Moreover, the terms “comprise”, “include”, or any other variants thereof, are intended to represent a non-exclusive inclusion, so that a process, method, article or device including a series of elements includes not only those elements, but also other elements that are not explicitly listed or elements inherent to such a process, method, article or device. Without more constraints, the elements following an expression “comprise/include...” do not exclude the existence of additional identical elements in the process, method, article or device that includes the elements.

It should be understood that the term “and/or” used herein refers to only an association relationship for describing associated objects, and means that there may be three kinds of relationships. For example, “A and/or B” can represent three cases including: “A alone”, “A and B”, and “B alone”. In addition, the character “/” in the present disclosure generally indicates that the associated objects have an “or” relationship.

It will be apparent to those skilled in the art that various modifications and variations can be made in the present disclosure without departing from the gist or scope of the present disclosure. Accordingly, the present disclosure is intended to cover modifications and variations of the present disclosure that fall within the scope of the corresponding claims (claimed technical solutions) and their equivalents. It should be noted that, the embodiments provided in the present disclosure can be combined with each other as long as there is no contradiction.

In the process of implementing the present disclosure, it is found that there is the following problem in the related art. In the current pixel circuits, within one display frame, due to issues such as current leakage of the driving transistor, the driving current generated by the driving transistor varies, resulting in differences in the light-emitting brightness of the light-emitting device, thereby causing the flicker of the display panel.

With the development of display technology, good screen display and ultra-long standby time have become important indicators to measure the quality of the display screen. To satisfy ultra-long standby time, the power consumption can be reduced by improving the light-emitting efficiency of a light-emitting material. Given the development of materials is difficult and has a lengthy cycle, the power consumption can typically be reduced by lowering the frequency (or referred to as refresh rate) of the display panel.

However, as the frequency of the display panel decreases, the time of one display frame (i.e., one frame time) becomes longer, and the time for the current leakage of the corresponding transistor also becomes longer, so that the flicker of the display panel becomes more severe.

In view of the above study, some embodiments of the present disclosure provide a method and an apparatus for driving a display panel, a display apparatus, and a computer readable storage medium, which can solve the flicker of the display panel in the related art.

The technical concept of the embodiments of the present disclosure is as follows. The display frame is divided into the plurality of display sub-frames that each includes the black insertion stage in which the target control signal is at the non-enable level and the light-emitting stage in which the target control signal is at the enable level, the target black insertion ratios include the black insertion ratios respectively corresponding to the plurality of black insertion stages in the display frame, and at least two of the black insertion ratios that correspond to at least two of the black insertion stages are different from each other; and the target control signal obtained based on the target black insertion ratios is provided to the display panel. Since the black insertion ratios of at least two of the black insertion stages in the display frame are different, and the target control signal is adjusted based on the target black insertion ratios, the obtained target control signal has different black insertion ratios of at least two black insertion stages, so that different display sub-frames in one display frame have the same or similar brightness, and the brightness of all display sub-frames in one frame time remains balanced, thereby significantly alleviating the flicker of the display panel.

First, the method for driving the display panel provided in the embodiments of the present disclosure will be described below.

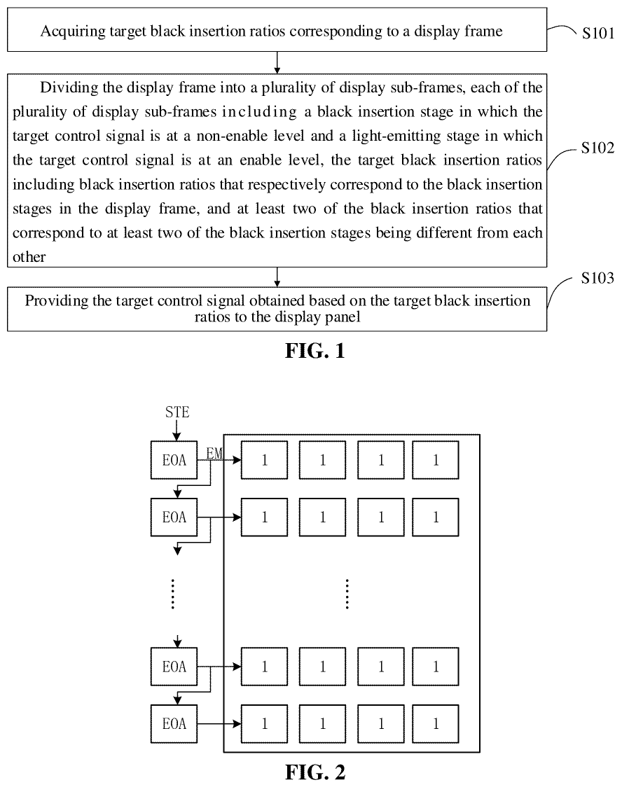

FIG. 1 is a flow chart of a method for driving a display panel provided by some embodiments of the present disclosure. As shown in FIG. 1, the method for driving a display panel can include following steps S101 to S103.

Before describing steps S101 to S103, the target control signal will be described first.

In the embodiments of the present disclosure, the display panel can emit light under a control of the target control signal. The target control signal can be output by a display driver integrated circuit (DDIC) and used to control the light emission of the display panel. Exemplarily, the target control signal includes, but is not limited to, a start signal (also referred to as a trigger signal) STE.

It can be understood that, as shown in FIG. 2, the display panel can include a light-emitting control signal output circuit, and the light-emitting control signal output circuit can include a plurality of shift registers EOA that are cascaded. The shift register EOA can be configured to output a light-emitting control signal EM. At the beginning of each frame, the start signal STE can be input to the first-stage shift register EOA, and the cascaded shift registers EOA sequentially output the light-emitting control signal EM, thereby driving light-emitting elements in the display panel to emit light. A waveform of the light-emitting control signal EM output from the shift register EOA in each stage is the same as or similar to the waveform of the start signal STE. That is, the light-emitting control signal EM is controlled by the start signal STE.

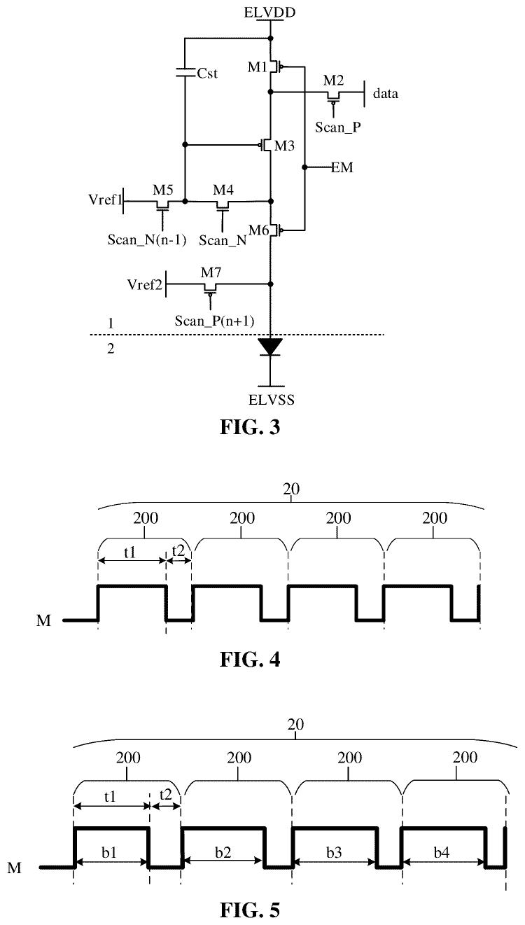

The display panel further includes pixel circuits 1, and the light-emitting control signals EM output from the shift registers EOA are transmitted to the pixel circuits 1. As shown in FIG. 3, the pixel circuit 1 is configured to drive the light-emitting element 2. As an example, the structure of the pixel circuit 1 can be as illustrated in FIG. 3, and the light-emitting control signal EM controls the transistors M1 and M6 to be turned on or turned off. When the light-emitting control signal EM controls the transistors M1 and M6 to be turned on, the light-emitting element 2 emits light; when the light-emitting control signal EM controls the transistors M1 and M6 to be turned off, the light-emitting element 2 does not emit light. It should be noted that the structure of the pixel circuit shown in FIG. 3 is not intended to limit the present disclosure. The pixel circuit may have other structures, which is not limited in the present disclosure.

Steps S101 to S103 are described below.

In S101, target black insertion ratios corresponding to a display frame are acquired.

Exemplarily, the display frame can be one frame to be displayed, i.e. the next frame. The target black insertion ratios can be used to adjust the durations (i.e., the pulse widths) of black insertion stages mentioned below.

In S102, the display frame is divided into a plurality of display sub-frames, each display sub-frame including a black insertion stage in which the target control signal is at a non-enable level and a light-emitting stage in which the target control signal is at an enable level, the target black insertion ratios including the black insertion ratios that respectively correspond to the black insertion stages in the display frame, and at least two of the black insertion ratios that correspond to at least two of the black insertion stages being different from each other.

FIG. 4 is a schematic diagram of a waveform of a target control signal. Referring to FIG. 4, a display frame 20 can be divided into a plurality of display sub-frames 200. Each display sub-frame 200 can include a black insertion stage t1 and a light-emitting stage t2. In the embodiments of the present disclosure, the number of the display sub-frames 200 in the display frame 20 is not limited, and FIG. 4 illustrates that the display frame 20 includes four display sub-frames 200 as an example, but the display frame 20 can include another number of the display sub-frames 200. In the black insertion stage t1, the target control signal M is at the non-enable level, and the corresponding sub-pixel does not emit light. In the light-emitting stage t2, the target control signal M is at the enable level, and the corresponding sub-pixel emits light. Exemplarily, the non-enable level can be a high level and the enable level can be a low level. Of course, in other embodiments, the non-enable level can be a low level and the enable level can be a high level, which is not limited in the embodiments of the present disclosure.

The target black insertion ratios can include the black insertion ratios respectively corresponding to the plurality of black insertion stages t1 in the display frame 20. In the same display frame 20, the black insertion ratios corresponding to at least two black insertion stages t1 can be different from each other. For example, the display frame includes four black insertion stages, and the target black insertion ratios include black insertion ratios b1, b2, b3, and b4 that respectively correspond to the four black insertion stages. At least two of the black insertion ratios b1, b2, b3, and b4 are different from each other.

For example, taking the display frame 20 including four display sub-frames 200 as an example, the black insertion ratio b1 corresponding to the black insertion stage t1 in the first display sub-frame 200 that is the earliest can be greater than the black insertion ratio b2 corresponding to the black insertion stage t1 in the second display sub-frame 200, the black insertion ratio b2 corresponding to the black insertion stage t1 in the second display sub-frame 200 can be greater than the black insertion ratio b3 corresponding to the black insertion stage t1 in the third display sub-frame 200, and the black insertion ratio b3 corresponding to the black insertion stage t1 in the third display sub-frame 200 can be greater than the black insertion ratio b4 corresponding to the black insertion stage t1 in the fourth display sub-frame 200; that is, the black insertion ratios decrease. For another example, the black insertion ratio b1 corresponding to the black insertion stage t1 in the first display sub-frame 200 that is the earliest can be smaller than the black insertion ratio b2 corresponding to the black insertion stage t1 in the second display sub-frame 200, the black insertion ratio b2 corresponding to the black insertion stage t1 in the second display sub-frame 200 can be smaller than the black insertion ratio b3 corresponding to the black insertion stage t1 in the third display sub-frame 200, the black insertion ratio b3 corresponding to the black insertion stage t1 in the third display sub-frame 200 can be smaller than the black insertion ratio b4 corresponding to the black insertion stage t1 in the fourth display sub-frame 200; that is, the black insertion ratios increase. Of course, in the same display frame 20, the black insertion ratios corresponding to some black insertion stages t1 can be the same, which is not limited in the embodiments of the present disclosure.

In S103, the target control signal obtained based on the target black insertion ratios is provided to the display panel.

After the black insertion ratio of the black insertion stage of the target control signal is adjusted, the target control signal can be provided to the display panel so that the display panel emits light under the control of the adjusted target control signal.

FIG. 5 is a schematic diagram of a waveform of an adjusted target control signal. Referring to FIGS. 4 and 5, still taking the display frame 20 including four display sub-frames 200 as an example, the target black insertion ratios include the black insertion ratios b1, b2, b3, and b4 respectively corresponding to the four black insertion stages. At least two of the black insertion ratios b1, b2, b3, and b4 are different from each other.

According to the method for driving the display panel provided in the embodiments of the present disclosure, the display frame is divided into the plurality of display sub-frames that each include the black insertion stage in which the target control signal is at the non-enable level and the light-emitting stage in which the target control signal is at the enable level; the target black insertion ratios include the black insertion ratios respectively corresponding to the plurality of black insertion stages in the display frame, and at least two of the black insertion ratios that correspond to at least two of the black insertion stages are different from each other. The target control signal obtained based on the target black insertion ratios is provided to the display panel. Since the black insertion ratios of at least two of the black insertion stages in the display frame are different, and the target control signal is adjusted based on the target black insertion ratios, the obtained target control signal has different black insertion ratios of at least two black insertion stages, so that different display sub-frames in one display frame have the same or similar brightness, and the brightness of all display sub-frames in one frame time remains balanced, thereby significantly alleviating the flicker of the display panel.

In some optional embodiments, all black insertion ratios in the target black insertion ratios are different from each other. For example, as shown in FIG. 5, four black insertion stages correspond to the black insertion ratios b1, b2, b3, and b4, respectively, and the black insertion ratios b1, b2, b3, and b4 are different from each other.

In some optional embodiments, the black insertion ratios in the target black insertion ratios vary linearly. Here, the linear variation can refer to varying linearly, allowing for a certain error, i.e., all the black insertion ratios in the target black insertion ratios can be substantially connected to form a straight line.

FIG. 6 is a schematic flow chart of S103 in the method for driving a display panel provided by some embodiments of the present disclosure. As shown in FIG. 6, in some embodiments of the present disclosure, optionally, S103 specifically includes the following steps S1031 and S1032.

In S1031, durations of all black insertion stages in the display frame are adjusted based on the black insertion ratios respectively corresponding to the black insertion stages in the display frame. The durations of at least two black insertion stages are different from each other.

Here, the black insertion ratio can be regarded as a ratio of the duration of the black insertion stage to a duration of the display sub-frame, or as a ratio of the durations of the black insertion stages to the duration of the entire display frame. Based on the black insertion ratio corresponding to each black insertion stage, the duration of each black insertion stage can be adjusted. The durations of at least two black insertion stages are different from each other.

FIG. 5 is a schematic diagram of a waveform of an adjusted target control signal. Referring to FIGS. 4 and 5, still taking the display frame 20 including four display sub-frames 200 as an example, for instance, when the current leakage causes the brightness of the display panel to change from dark to bright within one display frame 20, the black insertion ratios can be adjusted to increase sequentially during the black insertion stage t1 in the first display sub-frame 200 to the black insertion stage t1 in the fourth display sub-frame 200, i.e., the black insertion ratios satisfy b1<b2<b3<b4, which is shown in FIG. 5. Therefore, different display sub-frames within one display frame have the same or similar brightness, maintaining a balanced brightness for each display sub-frame over the frame time, and significantly alleviating the flicker of the display panel.

For another example, when the brightness of the display panel changes from bright to dark within one display frame 20, the black insertion ratios from the black insertion stage t1 in the first display sub-frame 200 to the black insertion stage t1 in the fourth display sub-frame 200 can be adjusted to decrease sequentially. Thus, different display sub-frames within one display frame have the same or similar brightness, maintaining a balanced brightness for each display sub-frame over the frame time, and significantly alleviating the flicker of the display panel.

In S1032, the target control signal obtained based on the adjusted durations of the black insertion stages is provided to the display panel.

After the durations of the black insertion stages of the target control signal is adjusted, the target control signal obtained based on the adjusted durations of the black insertion stages can be provided to the display panel, thereby causing the display panel to emit light under the control of the target control signal.

According to the method for driving the display panel provided in the embodiments of the present disclosure, the display frame is divided into the plurality of display sub-frames that each includes the black insertion stage in which the target control signal is at the non-enable level and the light-emitting stage in which the target control signal is at the enable level, and the target black insertion ratios include the black insertion ratios respectively corresponding to the plurality of black insertion stages in the display frame; and the durations of the black insertion stages in the display frame can be adjusted based on the black insertion ratios that respectively correspond to the plurality of black insertion stages in the display frame, so that different display sub-frames in one display frame have the same or similar brightness, and the brightness of each display sub-frame in one frame time remains balanced, thereby significantly alleviating the flicker of the display panel.

After extensive experiments, it is found that when data volumes (i.e., all display data) displayed in each frame of the display panel varies, the display panel flickers of different degree. Therefore, according to the present disclosure, the data volumes displayed in each frame of the display panel is divided into a plurality of different data volume ranges, and the different data volume ranges correspond to different black insertion ratios, so as to better alleviate the flicker of the display panel in each data volume range.

FIG. 7 is a schematic flow chart of S101 in the method for driving a display panel provided by some embodiments of the present disclosure. As shown in FIG. 7, in some embodiments of the present disclosure, optionally, S101 in which target black insertion ratios corresponding to a display frame is acquired specifically includes the following steps S401 and S402.

In S401, a target data volume for display in the display frame is acquired.

The grayscale to be displayed by each sub-pixel in the display frame is known, and therefore the target data volume for display in the display frame can be obtained.

It should be noted that the target data volume represents a volume of data to be displayed on the display panel in the display frame. The data volume corresponding to one sub-pixel of the display panel can has a value reflecting the grayscale. For example, if a sub-pixel needs to display a grayscale of 20 in a display frame, then the data volume corresponding to this sub-pixel is related to the grayscale of 20.

In S402, target black insertion ratios corresponding to the target data volume are determined based on a preset first correspondence relationship between a data volume and a black insertion ratio.

The first correspondence relationship between the data volume and the black insertion ratio can be preset, for example, the data volumes displayed in each frame of the display panel can be divided into a plurality of different data volume ranges, and different data volume ranges correspond to different black insertion ratios.

In S402, the target black insertion ratios corresponding to the target data volume can be determined based on the first correspondence relationship between the data volume and the black insertion ratio. As described above, when a display frame includes a plurality of black insertion stages, the target black insertion ratios can include the black insertion ratios respectively corresponding to the plurality of black insertion stages in the display frame. The black insertion ratios corresponding to different black insertion stages can be flexibly adjusted.

In this way, according to embodiments of the present disclosure, automatic adjustment of the black insertion ratios and automatic adjustment of the waveform of the target control signal can be achieved based on the data volumes of the input image, so that overall optimization of the flicker of the display panel can be achieved, thereby better alleviating the flicker of the display panel in each data volume range.

A display panel that actually needs to be driven or a sample display panel can be taken as a test display panel, and the test display panel can be pre-debugged to determine the first correspondence relationship between the data volume and the black insertion ratio. The process of determining the first correspondence relationship between the data volume and the black insertion ratio will be described below.

In some specific embodiments, the first correspondence relationship can be a correspondence relationship between a plurality of different data volume ranges and a plurality of black insertion ratios. Here, one data volume range includes at least one data volume. For example, the data volume range A can be a range from a1 to a2, the data volume range B can be a range from a3 to a4, and the data volume range C can be a range from a5 to a6. Here, a1 to a6 can be positive numbers. Different data volume ranges correspond to different black insertion ratios.

In some specific embodiments, the plurality of data volume ranges are in a one-to-one correspondence with a plurality of grayscale ranges. The display panel includes a plurality of brightness levels. The same grayscale range corresponds to different black insertion ratio at at least two different brightness levels. For example, the display panel displays the grayscales of 0 to 255. The grayscales of 0 to 255 are divided into four grayscale ranges, the number of data volume ranges can be four, and the four data volume ranges are in a one-to-one correspondence with four grayscale ranges.

The brightness level of the display panel can be adjusted via a display brightness value (DBV). Different DBVs correspond to different brightness performances. That is, the same grayscale image has different brightness at different brightness levels. According to the embodiments of the present disclosure, the same grayscale range corresponds to different black insertion ratios at at least two different brightness levels, which allows the brightness requirements for the grayscale ranges to be flexibly satisfied under different brightness levels.

In some specific embodiments, the display panel has a first refresh frequency and a second refresh frequency. The number of data volume ranges corresponding to the first refresh frequency is n1, the number of data volume ranges corresponding to the second refresh frequency is n2, and n1 and n2 satisfy n1≠n2, where both n1 and n2 are positive integers.

The number of data volume ranges can reflect the fineness of brightness adjustment for the display panel. The larger the number of data volume ranges, the finer the adjusted brightness. The flicker severity can differ under different refresh frequencies. In the embodiments of the present disclosure, the numbers of data volume ranges corresponding to different refresh frequencies are different, which facilitates flexibly satisfying different brightness adjustment and control requirements at different refresh frequencies.

In some specific embodiments, the first refresh frequency is smaller than the second refresh frequency, and n1>n2.

For example, the first refresh frequency is 15 HZ, and n1 is 22; the second refresh frequency is 120 HZ, and n2 is 20. Alternatively, other numerical values can also be set for these parameters.

Through research, it is found that the driving transistor in the pixel circuit can cause the display panel to flicker due to current leakage or hysteresis. The lower the refresh frequency, the longer the duration of one display frame; therefore, the current leakage or hysteresis of the transistor becomes more severe. That is, the lower the refresh frequency, the more serious the flicker. However, according to the embodiments of the present disclosure, since a lower refresh frequency corresponds to a greater number of data volume ranges, a greater number of data volume ranges enables finer adjustment of brightness, so that the severe flicker at low refresh frequency is thereby alleviated.

In some specific embodiments, the display panel has a first refresh frequency and a second refresh frequency, the first refresh frequency is smaller than the second refresh frequency. For the black insertion ratios of the black insertion stages corresponding to the same data volume range, a difference between the maximum black insertion ratio and the minimum black insertion ratio at the first refresh frequency is greater than a difference between the maximum black insertion ratio and the minimum black insertion ratio at the second refresh frequency. Since the lower the refresh frequency, the more serious the current leakage or hysteresis of the transistor can be, the more serious the flicker can be, and the difference between multiple display sub-frames in a display frame can be relatively large, the difference between the maximum black insertion ratio and the minimum black insertion ratio after the black insertion ratios are adjusted can be larger.

In some specific embodiments, the plurality of data volume ranges are in a one-to-one correspondence with a plurality of grayscale ranges, the display panel has a first refresh frequency and a second refresh frequency, and the same grayscale range corresponds to different the black insertion ratios at the first refresh frequency and the second refresh frequency.

Since the duration of the display frame differs under different refresh frequencies, the brightness performance for the same grayscale range varies at different refresh frequencies. For example, the flicker degree for the same grayscale range differs at different refresh frequencies. However, according to the embodiments of the present disclosure, the black insertion ratios of the same grayscale range at different refresh frequencies are different, which facilitates flexibly satisfying different brightness adjustment and control requirements for the same grayscale range at different refresh frequencies.

In some specific embodiments, the display panel can have a plurality of refresh frequencies. For different refresh frequencies, the black insertion ratios of the black insertion stages corresponding to different data volume ranges are also different. Since the duration of the display frame differs at different refresh frequencies, and the brightness performances of different data volume ranges varies at different refresh frequencies, the black insertion ratios of the corresponding black insertion stages can be set to be different accordingly.

In some specific embodiments, the display panel has a plurality of refresh frequencies. The number of the data volume ranges is in the range of 20 to 25 at at least one refresh frequency. In some specific embodiments, the number of the data volume ranges is 22 at at least one refresh frequency. Through extensive research, it is found that when the number of the data volume ranges is in the range of 20 to 25, it is possible to better alleviate the flicker of the display panel in overall, while balancing the issue of slow operation speed caused by excessively large data storage requirements.

In some specific embodiments, the data volume ranges include a first data volume range and a second data volume range. The maximum grayscale corresponding to the first data volume range is smaller than the minimum grayscale corresponding to the second data volume range, and the black insertion ratio corresponding to the first data volume range is greater than the black insertion ratio corresponding to the second data volume range.

For example, the display frame includes four black insertion stages. The black insertion ratios of four black insertion stages corresponding to the first data volume range each are respectively greater than the black insertion ratios of four black insertion stages corresponding to the second data volume range. For example, the black insertion ratios b11, b12, b13, and b14 of the first to fourth black insertion stages corresponding to the first data volume range and the black insertion ratios b21, b22, b23, and b24 of the first to fourth black insertion stages corresponding to the second data volume range satisfy b11>b21, b12>b22, b12>b23, b14>b24; or, each of the black insertion ratios of four black insertion stages corresponding to the first data volume range is greater than each of the black insertion ratios of four black insertion stages corresponding to the second data volume range.

That is, specifically, the black insertion ratios for the first data volume range corresponding to a low grayscale range (e.g., grayscales ranging from 0 to 85) can be relatively large, and the black insertion ratios for the second data volume range corresponding to a high grayscale range (e.g., grayscales ranging from 170 to 255) can be relatively small.

In some specific embodiments, the numbers of grayscales corresponding to at least two data volume ranges are different. The data volume ranges are in a one-to-one correspondence with the grayscale ranges, and the numbers of grayscales in at least two grayscale ranges are different. For example, a grayscale range corresponding to one data volume range includes ten grayscales, and a grayscale range corresponding to another data volume range includes twenty grayscales.

It can be understood that the greater number of grayscales corresponding to the data volume range, the smaller data volume need to be stored, but it also means that the greater number of grayscale images need to be accommodated. That is to say, the flicker of multiple grayscale images needs to be accommodated. However, the more grayscale images that need to be accommodated, the greater the difficulty in adjusting the brightness for grayscale images with more severe flicker. A smaller number of grayscales corresponding to the data volume range enables finer brightness adjustment and control for the data volume range.

The rate of brightness change varies with grayscale; therefore, the degree of flicker differs across different grayscale ranges. However, according to the embodiments of the present disclosure, the numbers of grayscales corresponding to at least two data volume ranges are different, which not only avoids occupying excessive storage space but also facilitates finer brightness adjustment and control for certain data volume ranges.

In some specific embodiments, the data volume ranges include a first data volume range and a second data volume range. The maximum grayscale corresponding to the first data volume range is smaller than the minimum grayscale corresponding to the second data volume range, and the number of grayscales corresponding to the first data volume range is smaller than the number of grayscales corresponding to the second data volume range.

Low grayscale images exhibit flickers more severely, and the first data volume range corresponding to the low grayscale corresponds to a relatively small number of grayscales, which avoids balancing too many grayscale images, thereby enabling finer adjustment and control for the low grayscale images.

In some specific embodiments, the plurality of data volume ranges are the first data volume range to the n-th data volume range. The maximum grayscale corresponding to the i-th data volume range is less than the minimum grayscale corresponding to the (i+1)-th data volume range, where n≥3, i and i+1 are any two adjacent numbers from 1 to n, and i and n are integers. From the first data volume range to the n-th data volume range, the numbers of grayscales respectively corresponding to the plurality of data volume ranges are in an increasing trend.

For example, when the grayscales of 0 to 255 are divided into multiple grayscale ranges, a grayscale range 1 includes grayscales of 1 to 10, a grayscale range 2 includes grayscales of 11 to 30, and a grayscale range 3 includes grayscales of 31 to 60, and so on. Here, the grayscale range 1 corresponds to the first data volume range, the grayscale range 2 corresponds to the second data volume range, and the grayscale range 3 corresponds to the third data volume range, and so on. That is, the low grayscale ranges have fewer grayscales, thereby achieving higher fineness in brightness adjustment.

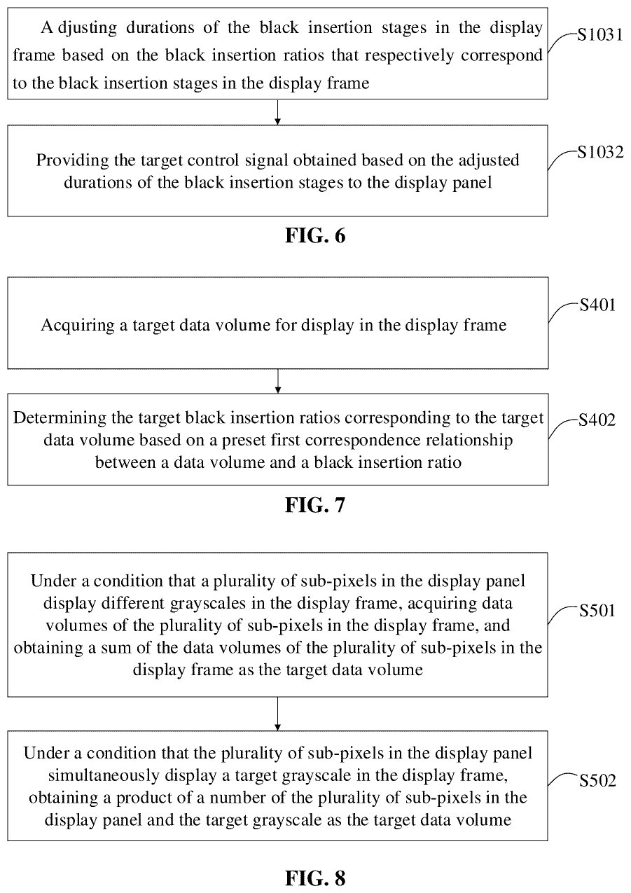

FIG. 8 is a schematic flow chart of S401 in the method for driving a display panel provided by some embodiments of the present disclosure. As shown in FIG. 8, in some embodiments of the present disclosure, optionally, S401 in which the target data volume for display in the display frame is acquired can include the following steps S501 and/or S502.

In S501, under a condition that a plurality of sub-pixels in the display panel display different grayscales in the display frame, the data volumes of each sub-pixel in the display frame is acquired, and a sum of the data volumes of all the sub-pixels in the display frame is obtained as the target data volume.

In the actual display process, a plurality of sub-pixels in the display panel can display different grayscales. Therefore, different sub-pixels can have different data volumes in the display frame. To obtain the target data volume more accurately, a sum of the data volumes of all the sub-pixels in the display frame can be obtain as the accurate target data volume.

For example, if the sub-pixel a displays the grayscale of 128 in the display frame, the data volume of the sub-pixel a can be 128. For example, if the sub-pixel b displays the grayscale of 255 in the display frame, the data volume of the sub-pixel b can be 255.

In S502, under a condition that a plurality of sub-pixels in the display panel simultaneously display a target grayscale in the display frame, a product of the number of the sub-pixels in the display panel and the target grayscale is obtained as the target data volume.

In some cases, the plurality of sub-pixels in the display panel can also display the same grayscale in the display frame. Under a condition that the plurality of sub-pixels in the display panel simultaneously display the target grayscale in a display frame, the product of the number of the plurality of sub-pixels in the display panel and the target grayscale can be obtain as the target data volume. The target grayscale can be any grayscale, which is not limited in the embodiments of the present disclosure.

For example, assuming that the resolution of the display panel is 100*100, the display panel includes sub-pixels of three colors, i.e., red, green, and blue, and the target grayscale is 192, the target data volume is 100*100*3*192.

In this way, by calculating the product of the number of the sub-pixels in the display panel and the target grayscale, the target data volume can be quickly obtained, shortening the time of the whole process of adjusting the waveform of the target control signal.

In some specific embodiments, in a case where the black insertion ratio is associated with a brightness level of the display panel, optionally, S401 in which the target data volume for display in the display frame is acquired can specifically include: determining the target data volume for display in the display frame based on the number of the sub-pixels of the display panel, the grayscale displayed by each sub-pixel in the display frame, and the brightness level of the display panel in the display frame.

For example, if the sub-pixel a displays the grayscale of 128 in the display frame, and the DBV corresponding to the brightness level of the display panel in the display frame is DBV1, the data volume of the sub-pixel a can be 128*DBV1. For example, if the sub-pixel b displays the grayscale of 255 in the display frame, and the DBV corresponding to the brightness level of the display panel in the display frame is DBV1, the data volume of the sub-pixel b can be 255*DBV1. The target data volume can be obtained by adding the data volumes of all the sub-pixels in the display frame.

For example, assuming that the resolution of the display panel is 100*100, the display panel includes sub-pixels of three colors, i.e., red, green, and blue, all sub-pixels has the target grayscale of 192, and the DBV corresponding to the brightness level of the display panel in the display frame is DBV2, then the target data volume is 100*100*3*192*DBV2.

In other embodiments of the present disclosure, optionally, S401 in which the target data volume for display in the display frame is acquired can specifically include: acquiring a display area of the display panel in the display frame, and obtaining the target data volume based on the display area. For example, the target data volume is obtained based on a ratio of the displayed area of the display panel in the display frame to an area of a display region of the display panel.

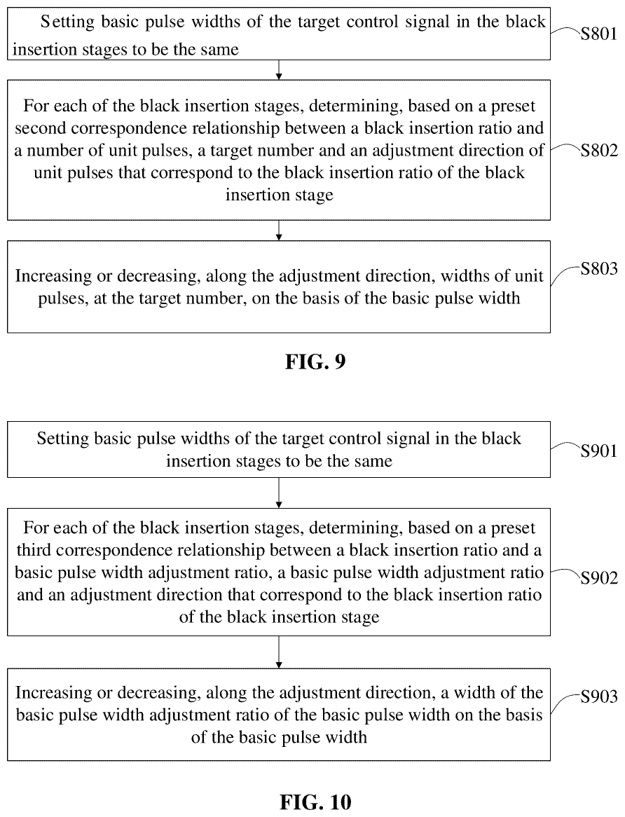

FIG. 9 is a schematic flow chart of S1031 in the method for driving a display panel provided by some embodiments of the present disclosure. As shown in FIG. 9, in some embodiments of the present disclosure, optionally, S1031 in which the durations of the black insertion stages in the display frame are adjusted based on the black insertion ratios corresponding to the black insertion stages in the display frame can specifically include the following steps S801 to S803.

In S801, basic pulse widths of the target control signal in the black insertion stages are set to be the same.

The basic pulse widths for the black insertion stages within the same display frame can be set to be the same. Based on the basic pulse widths, the pulse width (or duration) of the target control signal in the black insertion stages is fine-adjusted.

In S802, for any one of the black insertion stages, based on a preset second correspondence relationship between a black insertion ratio and the number of unit pulses, a target number and an adjustment direction of unit pulses that correspond to the black insertion ratio of the black insertion stage are determined.

The adjustment direction includes increase or decrease, also referred to as positive or negative. That is, based on the original basic pulse width, the widths of a certain number of unit pulses can be increased or decreased. Whether to increase or decrease is determined by whether the black insertion ratio increases or decreases.

The second correspondence relationship between the black insertion ratio and the number of unit pulses can be preset. For example, if the initial black insertion ratio is 80%, then a black insertion ratio of 70% can correspond to decreasing by a width of two unit pulses, and a black insertion ratio of 90% can correspond to increasing by a width of two unit pulses.

Thus, based on the second correspondence relationship, the target number and the adjustment direction of unit pulses that correspond to the black insertion ratio of each black insertion stage can be determined.

In S803, widths of unit pulses, at the target number, are increased or decreased on the basis of the basic pulse width in the black insertion stage along the adjustment direction.

For any one of the black insertion stages, the widths of unit pulses, the target number, are increased or decreased on the basis of the basic pulse width along the adjustment direction.

For example, when the black insertion stage corresponds to a black insertion ratio of 70%, widths of two unit pulses can be decreased on the basis of the basic pulse width. For example, when the black insertion stage corresponds to a black insertion ratio of 90%, widths of two unit pulses can be increased on the basis of the basic pulse width.

The above description that the black insertion ratio of 70% can correspond to decreasing by the width of two unit pulses and the black insertion ratio of 90% can correspond to increasing widths of two unit pulses is for illustrative purposes only and does not limit the present disclosure.

Table 1 schematically shows the black insertion ratio and driving current in the related art. Table 2 schematically shows the black insertion ratio and the driving current in the embodiments of the present disclosure.

TABLE 1

| Black insertion stage/Display sub-frame | 1 | 2 | 3 | 4 |
|---|---|---|---|---|
| Black insertion ratio | 3% | 3% | 3% | 3% |
| Driving current (nA) | 223.42 | 224.33 | 224.2 | 224.1 |

TABLE 2

| Black insertion | | | | |
|---|---|---|---|---|
| stage/Display sub-frame | 1 | 2 | 3 | 4 |
| Black insertion ratio | 2.9334% | 3.0224% | 3.0096% | 3.0099% |
| Driving current (nA) | 224.1 | 224.1 | 224.1 | 224.1 |

As shown in Table 1 and Table 2, taking a refresh frequency of 15 Hz and one display frame including four display sub-frames as an example, a fixed black insertion ratio is adopted in the related art, and each black insertion stage occupies 3% of a frame time, and the total black insertion time occupies 12% of the frame time. In this case, the driving currents in the four display sub-frames are different; for instance, the driving current in the first display sub-frame is 223.42 nA, the driving current in the second display sub-frame is 224.33 nA, the driving current in the third display sub-frame is 224.2 nA, and the driving current in the fourth display sub-frame is 224.1 nA. Due to different driving currents, the brightness of the display panel in four display sub-frames is also different, resulting in flicker. According the embodiments of the present disclosure, the black insertion ratios are adjusted, the black insertion ratio for each black insertion stage is no longer fixed but can be flexibly adjusted. For example, the black insertion ratio of the first black insertion stage is 2.9334%, the black insertion ratio of the second black insertion stage is 3.0224%, the black insertion ratio of the third black insertion stage is 3.0096%, and the black insertion ratio of the fourth black insertion stage is 3.0099%. In this way, the driving currents in the four display sub-frames can be the same, thereby making the brightness of the display panel uniform in four display sub-frames and alleviating the flicker.

FIG. 10 is a schematic flow chart of S1031 in the method for driving a display panel provided by some embodiments of the present disclosure. As shown in FIG. 10, in other embodiments of the present disclosure, optionally, S1031 in which the durations of the black insertion stage in the display frame are adjusted based on the black insertion ratios respectively corresponding to the black insertion stages in the display frame can specifically include the following steps S901 to S903.

In S901, basic pulse widths of the target control signal in the black insertion stages are set to be the same.

The basic pulse widths for the black insertion stages in the same display frame can be set to be the same. Based on the basic pulse widths, the basic pulse width ratios of the target control signal in the black insertion stages are fine-adjusted.

In S902, for any one of the black insertion stages, based on a preset third correspondence relationship between a black insertion ratio and a basic pulse width adjustment ratio, a basic pulse width adjustment ratio and an adjustment direction that correspond to the black insertion ratio of the black insertion stage are determined, where the adjustment direction includes increase or decrease.

The adjustment direction includes increase or decrease, also referred to as positive or negative. That is, based on the original basic pulse width, a width of a certain basic pulse width ratio of the original basic pulse width can be increased or a width of a certain basic pulse width ratio of the original basic pulse width can be reduced. Whether to increase or decrease is determined by whether the black insertion ratio increases or decreases.

The third correspondence relationship between the black insertion ratio and the basic pulse width adjustment ratio can be preset. For example, based on a set basic pulse width and a set ratio of 1% (which is 1% of the basic pulse width), an adjustment of 1% is made each time, for example, by increasing or decreasing by 1%.

Then, based on the third correspondence relationship, the basic pulse width adjustment ratio corresponding to the black insertion ratio of each black insertion stage can be determined.

In S903, a width of the basic pulse width adjustment ratio of the basic pulse width is increased or decreased on the basis of the basic pulse width along the adjustment direction. For any one of the black insertion stages, a width of the basic pulse width adjustment ratio of the basic pulse width is increased or decreased on the basis of the basic pulse width along the adjustment direction.

Hereinafter, a process of determining the first correspondence relationship between the data volume and the black insertion ratio will be described in detail.

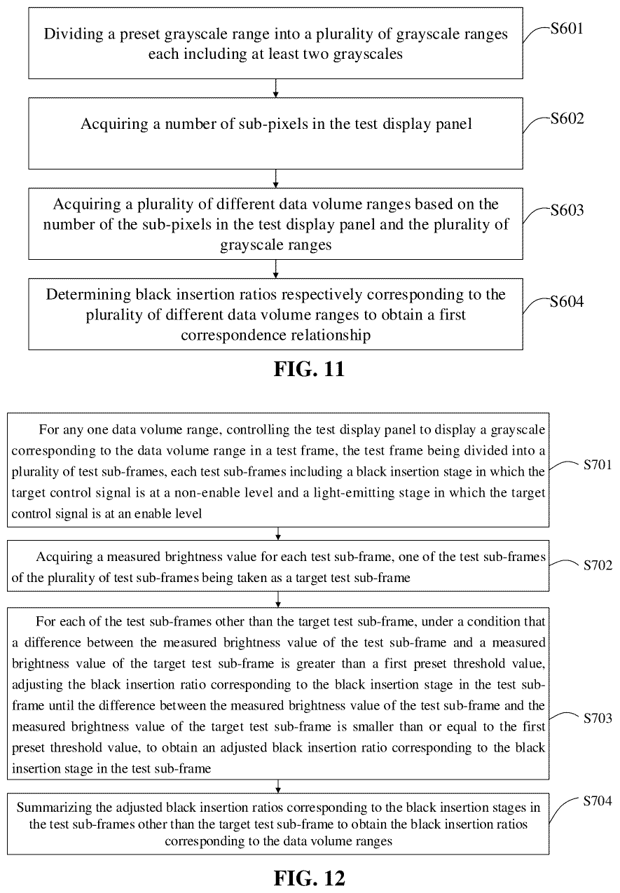

FIG. 11 is a schematic flow chart of a method for debugging a display panel provided by some embodiments of the present disclosure. As shown in FIG. 11, in some embodiments of the present disclosure, optionally, the method for debugging a display panel can include the following steps S601 to S604.

In S601, a preset grayscale range is divided into a plurality of grayscale ranges, each including at least two grayscales.

The preset grayscale range can be flexibly adjusted based on actual situations. For example, the preset grayscale range includes, but is not limited to, grayscales of 0 to 255. The preset grayscale range can be divided into a plurality of grayscale ranges in a descending or ascending order. The numbers of grayscales in different grayscale ranges can be the same or different. For example, every N grayscales form a grayscale range, and N is a positive integer. For another example, the first grayscale range includes N1 grayscales, the second grayscale range includes N2 grayscales, . . . , and the n-th grayscale range includes Nn grayscales, where, N1≠N2≠N3, and n, N1, N2, and N3 are all positive integers.

In S602, the number of the sub-pixels in a test display panel is acquired.

The test display panel can be a display panel according to the embodiment of the present disclosure or another display panel of the same model and/or the same production batch as the display panel according to the embodiment of the present disclosure. That is, the test display panel and the display panel according to the embodiments of the present disclosure have the same number of sub-pixels and the same or similar flicker.

In S603, based on the number of the sub-pixels in the test display panel and the plurality of grayscale ranges, a plurality of different data volume ranges are acquired.

In some specific embodiments, S603 can specifically include the following step one and step two.

In step one, for any one of the grayscale ranges, a product of the number of the sub-pixels in the test display panel and the minimum grayscale in the grayscale range is obtained as a first data volume, a product of the number of the sub-pixels in the test display panel and the maximum grayscale in the grayscale range is obtained as a second data volume.

For example, assuming that the display panel has a resolution of 100*100 and includes sub-pixels of three colors, i.e., red, green, and blue, and one grayscale range is from 128 to 255, the minimum grayscale in this grayscale range is a grayscale of 128, and the maximum grayscale in this grayscale range is a grayscale of 255.

The first data volume can be 100*100*3*128, and the second data volume can be 100*100*3*255. Here, 100*100*3 represents the number of the sub-pixels in the test display panel.

In step two, based on the first data volume and the second data volume, the data volume range corresponding to the grayscale range is obtained.

Here, a range from the first data volume to the second data volume can serve as the data volume range corresponding to the grayscale range.

Still taking the grayscale range from 128 to 255 as an example, the data volume range corresponding to the grayscale range from 128 to 255 can be 3,840,000 to 7,650,000.

In S604, the black insertion ratio corresponding to each data volume range is determined to obtain a first correspondence relationship.

After the data volume ranges are divided, the test display panel is controlled to sequentially display display contents corresponding to each data volume range. When the display contents corresponding to each data volume range are displayed, the black insertion ratio in one frame can be adjusted so that the brightness in all stages in one frame remains stable to obtain the black insertion ratios respectively corresponding to the data volume ranges. After the black insertion ratio corresponding to each data volume range is obtained, the first correspondence relationship between the data volume and the black insertion ratio can be obtained by summarizing or fitting.

FIG. 12 is a schematic flow chart of S604 in the method for driving a display panel provided by some embodiments of the present disclosure. As shown in FIG. 12, in some embodiments of the present disclosure, optionally, S604 in which the black insertion ratio corresponding to each data volume range is determined to obtain a first correspondence relationship can specifically include the following steps S701 to S704.

In S701, for any one of the data volume ranges, the test display panel is controlled to display a grayscale corresponding to the data volume range in a test frame, the test frame being divided into a plurality of test sub-frames, each test sub-frame including a black insertion stage in which a target control signal is at a non-enable level and a light-emitting stage in which the target control signal is at an enable level.

It is easy to understand that when the test display panel displays different grayscale images, the test display panel displays different data volumes. Then, each data volume range can correspond to at least one grayscale image. In a test stage, for any one of the data volume ranges, the test display panel can be controlled to display a grayscale (image) corresponding to the data volume range in the test frame.

Similar to the display frame, the test frame can be divided into a plurality of test sub-frames. The number of the test sub-frames in the test frame can equal to the number of the display sub-frames in the display frame. Each test sub-frame can also include a black insertion stage in which the target control signal is at a non-enable level and a light-emitting stage in which the target control signal is at an enable level.

In S702, a measured brightness value in each test sub-frame is acquired, and one of the test sub-frames is taken as a target test sub-frame.

The ultimate goal is to make the test display panel have the same or similar brightness in each test sub-frame. Therefore, the measured brightness value of the test display panel in each test sub-frame can be measured by an optical detection device (such as a color analyzer), one of the test sub-frames can be taken as a target test sub-frame, and the brightness value in the target test sub-frame can serve as a reference brightness value. It can be understood that the measured brightness value can be an overall brightness value of the test display panel or an average value of the overall brightness values of the test display panel, which can be specifically set based on the actual situation, and is not limited herein.

Considering that the brightness value in the first test sub-frame is close to a desired display brightness value, in some examples, the first test sub-frame can serve as the target test sub-frame, and the brightness value in the first test sub-frame can serve as the reference brightness value. Of course, another test sub-frame can be taken as the target test sub-frame, such as the last test sub-frame, which is not limited in the embodiments of the present disclosure.

In S703, for any one of the test sub-frames other than the target test sub-frame, under a condition that a difference between the measured brightness value in the test sub-frame and the measured brightness value in the target test sub-frame is greater than a first preset threshold value, the black insertion ratio corresponding to the black insertion stage in the test sub-frame is adjusted until the difference between the measured brightness value in the test sub-frame and the measured brightness value in the target test sub-frame is smaller than or equal to the first preset threshold value, so as to obtain the adjusted black insertion ratio corresponding to the black insertion stage in the test sub-frame.

Here, the first preset threshold value can be flexibly adjusted based on the actual situation, which is not limited in the embodiments of the present disclosure. Taking the test frame including four test sub-frames as an example, for example, the first test sub-frame can serve as the target test sub-frame, and the actual measured brightness value in the first test sub-frame can be taken as the reference brightness value. When a difference between the measured brightness value in the second test sub-frame and the measured brightness value in the first test sub-frame is greater than the first preset threshold value, the black insertion ratio corresponding to the black insertion stage in the second test sub-frame is adjusted until the difference between the measured brightness value in the second test sub-frame and the measured brightness value in the first test sub-frame is smaller than or equal to the first preset threshold value, thereby obtaining the adjusted black insertion ratio corresponding to the black insertion stage in the second test sub-frame. Similarly, the adjusted black insertion ratio corresponding to the black insertion stage in the third test sub-frame and the adjusted black insertion ratio corresponding to the black insertion stage in the fourth test sub-frame are obtained.

In S704, the adjusted black insertion ratio corresponding to the black insertion stage in each test sub-frame is summarized to obtain the black insertion ratio corresponding to the data volume range.

In this way, the adjusted black insertion ratio corresponding to the black insertion stage in each test sub-frame corresponding to the data volume range can be summarized to obtain the black insertion ratio corresponding to the data volume range.

It should be noted that since the black insertion ratio corresponding to the black insertion stage in the target test sub-frame is not adjusted, the black insertion ratio corresponding to the black insertion stage in the target test sub-frame can be the initial black insertion ratio, and the initial black insertion ratio is known.

After the black insertion ratios corresponding to all data volume ranges are obtained, the first correspondence relationship between the data volume and the black insertion ratio can be obtained by summarizing or fitting.

In some embodiments of the present disclosure, optionally, the black insertion ratio corresponding to each data volume range, or the first correspondence relationship, can be stored in the DDIC. In the subsequent use, the corresponding black insertion ratio can be directly called from the DDIC to adjust the waveform of the target control signal.

Based on the method for driving a display panel provided by the above embodiments, the present disclosure also provides specific embodiments of an apparatus for driving a display panel accordingly. Here, the display panel is configured to emit light under the control of the target control signal. Following embodiments can be referred to.

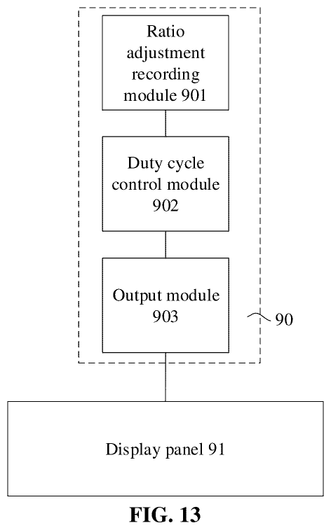

FIG. 13 is a schematic structural diagram of an apparatus for driving a display panel provided by some embodiments of the present disclosure. As shown in FIG. 13, the apparatus 90 for driving a display panel can include a ratio adjustment recording module 901, a duty cycle control module 902, and an output module 903.

The ratio adjustment recording module 901 is configured to acquire target black insertion ratios corresponding to a display frame.

The duty cycle control module 902 is configured to divide the display frame into a plurality of display sub-frames. Each display sub-frame includes a black insertion stage in which the target control signal is at a non-enable level and a light-emitting stage in which the target control signal is at an enable level, the target black insertion ratios include black insertion ratios respectively corresponding to the plurality of black insertion stages in the display frame, and the black insertion ratios corresponding to at least two black insertion stages are different.

The output module 903 is configured to provide the target control signal obtained based on the target black insertion ratio to the display panel 91.

It should be noted that the specific implementation of the steps performed by the ratio adjustment recording module 901, the duty cycle control module 902, and the output module 903 has been described in detail above, and will not be repeated herein.

According to the apparatus for driving the display panel in the embodiments of the present disclosure, the ratio adjustment recording module 901 is configured to acquire the target black insertion ratios corresponding to the display frame; the duty cycle control module 902 is configured to divide the display frame into the plurality of display sub-frames, where each display sub-frame includes the black insertion stage in which the target control signal is at the non-enable level and the light-emitting stage in which the target control signal is at the enable level, the target black insertion ratio includes the black insertion ratios respectively corresponding to the plurality of black insertion stages in the display frame, and the black insertion ratios corresponding to at least two black insertion stages are different; and the output module 903 is configured to provide the target control signal obtained based on the target black insertion ratios to the display panel. Since the black insertion ratios of at least two of the black insertion stages in the display frame are different, and the target control signal is adjusted based on the target black insertion ratios, the obtained target control signal has different black insertion ratios of at least two black insertion stages, so that different display sub-frames in one display frame has the same or similar brightness, and the brightness of all display sub-frames in one frame time remains balanced, thereby significantly alleviating the flicker of the display panel.

In some embodiments of the present disclosure, optionally, the duty cycle control module 902 is further configured to adjust duration of each black insertion stage in the display frame based on the black insertion ratio corresponding to the black insertion stage in the display frame, where the durations of at least two black insertion stages are different.

The output module 903 is configured to provide the target control signal obtained based on the adjusted durations of the black insertion stages to the display panel 91.

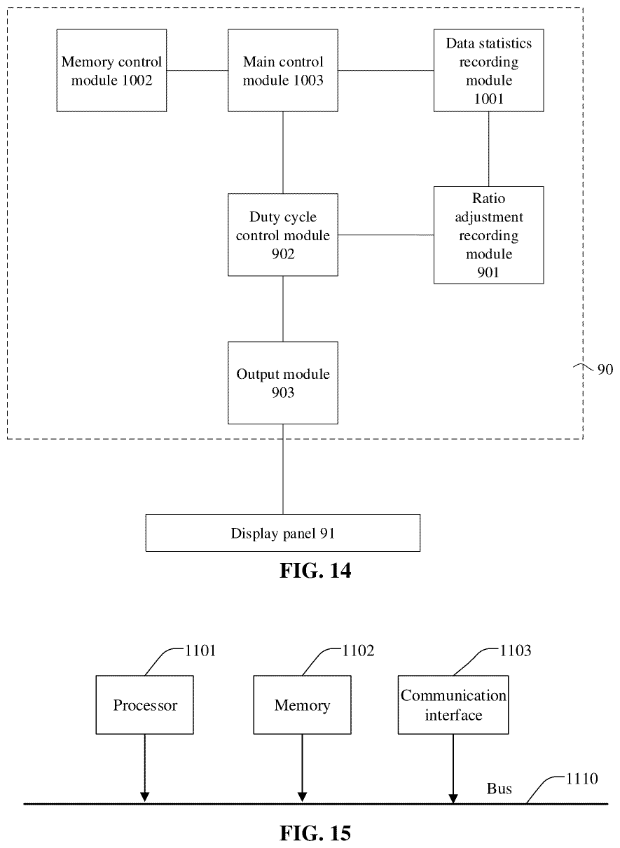

FIG. 14 is another schematic structural diagram of an apparatus for driving a display panel provided by some embodiments of the present disclosure. As shown in FIG. 14, in some embodiments of the present disclosure, optionally, the apparatus 90 for driving a display panel can further includes a data statistics recording module 1001 configured to acquire a target data volume for display in the display frame. The ratio adjustment recording module 901 is specifically configured to determine a target black insertion ratio corresponding to the target data volume based on a preset first correspondence relationship between a data volume and a black insertion ratio. The driving apparatus 90 includes, but is not limited to, a DDIC.

In this way, by adding the data statistics recording module 1001 and the ratio adjustment recording module 901 inside the DDIC, the black insertion ratio of each black insertion stage in each frame can be automatically adjusted, and the flicker of different images can be alleviated, and the alleviation effect can be extended. Furthermore, the black insertion ratio and the waveform of the target control signal can be automatically adjusted based on the different data volumes of the input image, thereby alleviating the flicker of the display panel in overall, and better alleviating the flicker of the display panel in each data volume range.

In some embodiments of the present disclosure, optionally, the first correspondence relationship is a correspondence relationship between a plurality of different data volume ranges and a plurality of black insertion ratios, one data volume range includes at least one data volume, and different data volume ranges correspond to different black insertion ratios.

Still referring to FIG. 14, in some embodiments of the present disclosure, optionally, the apparatus 90 for driving a display panel can further includes a memory control module 1002 and a main control module 1003, and the memory control module 1002 is configured to receive display data to be displayed in the display frame. The main control module 1003 is communicatively connected to the memory control module 1002, and is configured to transmit the display data to be displayed in the display frame to the data statistics recording module 1001. The data statistics recording module 1001 is specifically configured to calculate the target data volume for display in the display frame based on the display data to be displayed in the display frame.

In some embodiments of the present disclosure, optionally, the data statistics recording module 1001 is specifically configured to, under a condition that a plurality of sub-pixels in the display panel display different grayscales in a display frame, acquire data volumes of all sub-pixels in the display frame, and obtain a sum of the data volumes of all the sub-pixels in the display frame as the target data volume, and configured to, under a condition that a plurality of sub-pixels in the display panel simultaneously display the target grayscale in a display frame, obtain a product of the number of the sub-pixels in the display panel and the target grayscale as the target data volume.

In some embodiments of the present disclosure, optionally, the duty cycle control module 902 is specifically configured to: set basic pulse widths of the target control signal in the black insertion stages to be the same; for any one of the black insertion stages, based on a preset second correspondence relationship between a black insertion ratio and the number of unit pulses, determine the target number and an adjustment direction of the unit pulses corresponding to the black insertion ratio of the black insertion stage, the adjustment direction including increase or decrease; and increase or decrease widths of unit pluses, the target number, on the basis of the basic pulse width along the adjustment direction.

The various modules/units in the apparatus shown in FIGS. 13 and 14 have the functions of implementing the various steps of the method for driving a display panel provided in the above embodiments, and can achieve corresponding technical effects thereof, which is not repeated herein for brevity.

Some embodiments of the present disclosure further provide a display apparatus including a display panel and the apparatus for driving a display panel according to any of the above embodiments. The display apparatus provided in the embodiments of the present disclosure can be a mobile phone, a wearable product, a computer, a television, a vehicle-mounted display apparatus, and other display apparatus with display function, which is not limited in present disclosure. The display apparatus according to the embodiments of the present disclosure has the beneficial effects of the apparatus for driving a display panel provided in the embodiments of the present disclosure, reference can be made to the specific description of the apparatus for driving a display panel in the above embodiments for details, which is not repeated herein.

Based on the method for debugging a display panel provided in the above-embodiments, the embodiments of the present disclosure further provide a specific implementation of an electronic device accordingly. Please see the following embodiments.

FIG. 15 is a hardware schematic diagram of an electronic device provided by some embodiments of the present disclosure.

The electronic device can include a processor 1101 and a memory 1102 storing computer program instructions.

Specifically, the processor 1101 above can include a central processing unit (CPU), or an application specific integrated circuit (ASIC), or one or more integrated circuits configured to implement the embodiments of the present disclosure.

The memory 1102 can include mass memory for data or instructions. By way of example but not limitation, the memory 1102 can include a hard disk drive (HDD), a floppy disk drive, a flash memory, an optical disk, a magneto-optical disk, a magnetic tape, or a universal serial bus (USB) drive, or a combination of two or more thereof. In some instances, the memory 1102 can include a removable or non-removable (or fixed) medium, or the memory 1102 can be a non-volatile solid state memory. The memory 1102 can be internal or external to the electronic device.

In an example, the memory 1102 can be a read-only memory (ROM). In an example, the ROM can be a mask programmed ROM, a programmable ROM (PROM), an erasable PROM (EPROM), an electrically erasable PROM (EEPROM), an electrically alterable ROM (EAROM), or a flash memory, or a combination of two or more of them.

The memory 1102 can include a read-only memory (ROM), a random access memory (RAM), a magnetic disk storage media device, an optical storage media device, a flash memory device, or an electrical, optical or other physical/tangible memory storage device. Thus, the memory generally includes one or more tangible (non-transitory) computer readable storage media (for example, memory devices) encoded with software which includes computer-executable instructions, the software, when executed (for example, by one or more processors), is operable to perform the operations described with reference to the method for driving a display panel or the method for debugging a display panel according to an aspect of the present disclosure.

The processor 1101, by reading and executing computer program instructions stored in the memory 1102, implements the methods/steps in the embodiments and achieves the corresponding technical effects by the instances performing the methods/steps thereof, which is not repeated herein for brevity.

In an example, the electronic device can further include a communication interface 1103 and a bus 1110. As shown in FIG. 15, the processor 1101, the memory 1102, and the communication interface 1103 are connected by the bus 1110 to communicate with each other.

The communication interface 1103 is mainly configured to achieve communication between the modules, apparatuses, units, and/or devices in the embodiments of the present disclosure.

The bus 1110 includes hardware, software, or both of them, to couple components of the electronic device to each other. As an example rather than limitation, the bus can include an accelerated graphics port (AGP) or other graphics bus, an extended industry standard architecture (EISA) bus, a front side bus (FSB), a hyper transport (HT) interconnect, an industry standard architecture (ISA) bus, wireless band interconnect, a low pin count (LPC) bus, a memory bus, a micro channel architecture (MCA) bus, a peripheral component interconnect (PCI) bus, a PCI-Express (PCI-X) bus, a serial advanced technology attachment (SATA) bus, a video electronics standards association local bus (VLB) or other suitable bus or the combination of two or more of them. Where appropriate, the bus 1110 can include one or more buses. Although the particular buses are described and shown in the embodiments of the present disclosure, any suitable bus or interconnect is adopted in the present disclosure.

In addition, some embodiments of the present disclosure can provide a computer readable storage medium to implement in conjunction with the method for driving a display panel or the method for debugging a display panel in the embodiments described above. The computer readable storage medium stores computer program instructions thereon, in which the computer program instructions, when executed by a processor, implement any of the method for driving a display panel and a method for debugging a display panel in the above embodiments. An example of the computer readable storage medium includes a non-transitory computer readable storage media such as an electronic circuit, a semiconductor memory device, a ROM, a random access memory, a flash memory, an erasable ROM (EROM), a floppy disk, a CD-ROM, an optical disk, and a hard disk.

It should be noted that the present disclosure is not limited to the particular configurations and processes described above and shown in the drawings. For brevity, the detailed description of the known method is omitted herein. In the above embodiments, several specific steps are described and shown as examples. However, the method and the process of the present disclosure are not limited to the specific steps described and shown, and those skilled in the art can make various changes, modifications and additions, or change the sequence of the steps after comprehending the gist of the present disclosure.

The functional modules shown in the structural block diagrams can be implemented as hardware, software, firmware, or a combination thereof. When implemented as hardware, it can be, for example, an electronic circuit, an application specific integrated circuit (ASIC), appropriate firmware, a plug-in, a function card, or the like. When implemented as software, the elements of the present disclosure are programs or code segments which are used for executing a desired task. The programs or code segments can be stored in a machine-readable medium or transmitted by a data signal carried in a carrier wave over a transmission medium or communication link. The “machine-readable medium” can include any medium capable of storing or transmitting information. An example of the machine-readable medium includes an electronic circuit, a semiconductor memory device, a ROM, a flash memory, an erasable ROM (EROM), a floppy disk, a CD-ROM, an optical disk, a hard disk, a fiber optic medium, a radio frequency (RF) link, and the like. The code segment can be downloaded via a computer network such as the Internet, intranet, or the like.

It should also be noted that, in the exemplary embodiments mentioned in the present disclosure, some methods or systems are described based on a series of steps or apparatuses. However, the order of the above steps is not limited by the present disclosure, that is, the steps can be executed in the order mentioned in the embodiments, or can be performed in the order different from that in the embodiments, or several steps can be executed at the same time.

Aspects of the present disclosure are described above with reference to flowcharts and/or block diagrams of methods, devices (systems) and computer program products according to the embodiments of the present disclosure. It should be understood that each block in the flowcharts and/or block diagrams and combinations of blocks in the flowcharts and/or block diagrams can be implemented by the computer program instructions. These computer program instructions can be provided to a processor of a general purpose computer, a special purpose computer or other programmable data processing apparatuses to produce a machine, so that these instructions which are executed by the processor of the computer or other programmable data processing apparatuses enable the implementation of the functions/actions specified in one or more blocks of the flowcharts and/or block diagrams. Such a processor can be, but is not limited to, a general purpose processor, a special purpose processor, an application specific processor, or a field programmable logic circuit. It can also be understood that each block in the block diagrams and/or flowcharts and the combinations of blocks in the block diagrams and/or flowcharts can also be implemented by special purpose hardware that executes the specified functions or actions or can be implemented by the combinations of the special purpose hardware and the computer instructions.

The above presents only specific embodiments of the present disclosure, those skilled in the art can clearly understand that the specific operating processes of the above systems, modules and units can be referred to the corresponding processes in the embodiments of the foregoing method, which is not repeated herein for the convenience and brevity of the description. It should be understood that the scope of the present disclosure is not limited thereto, and any person skilled in the art can easily think of various equivalent modifications or replacements in the technical scope disclosed by the present disclosure, and these modifications or replacements should be covered by the scope of the present disclosure.

What is claimed is:

1. A method, adapted for driving a display panel that is configured to emit light under a control of a target control signal, the method comprising:
acquiring target black insertion ratios corresponding to a display frame;
dividing the display frame into a plurality of display sub-frames, wherein
each of the plurality of display sub-frames comprises a black insertion stage in which the target control signal is at a non-enable level and a light-emitting stage in which the target control signal is at an enable level, and
the target black insertion ratios comprise black insertion ratios that respectively correspond to the black insertion stages of the plurality of display sub-frames in the display frame, and at least two of the black insertion ratios that correspond to at least two of the black insertion stages are different from each other; and
providing the target control signal obtained based on the target black insertion ratios to the display panel.

2. The method according to claim 1, wherein the providing the target control signal obtained based on the target black insertion ratios to the display panel comprises:
adjusting durations of the black insertion stages in the display frame based on the black insertion ratios that respectively correspond to the black insertion stages in the display frame, at least two of the black insertion stages having different durations; and
providing the target control signal obtained based on the adjusted durations of the black insertion stages to the display panel.

3. The method according to claim 1, wherein the acquiring target black insertion ratios corresponding to a display frame comprises:
acquiring a target data volume for display in the display frame; and
determining the target black insertion ratios corresponding to the target data volume based on a preset first correspondence relationship between a data volume and a black insertion ratio.

4. The method according to claim 3, wherein the first correspondence relationship is a correspondence relationship between a plurality of different data volume ranges and a plurality of black insertion ratios, one of the plurality of data volume ranges comprising at least one data volume, and the plurality of data volume ranges corresponding to different ones of the plurality of black insertion ratios.

5. The method according to claim 3, wherein the acquiring a target data volume for display in the display frame comprises:
under a condition that a plurality of sub-pixels in the display panel display different grayscales in the display frame, acquiring data volumes of the plurality of sub-pixels in the display frame, and obtaining a sum of the data volumes of the plurality of sub-pixels in the display frame as the target data volume; or
under a condition that the plurality of sub-pixels in the display panel simultaneously display a target grayscale in the display frame, obtaining a product of a number of the plurality of sub-pixels in the display panel and the target grayscale as the target data volume.

6. The method according to claim 2, wherein the adjusting durations of the black insertion stages in the display frame based on the black insertion ratios that respectively correspond to the black insertion stages in the display frame comprises:
setting basic pulse widths of the target control signal in the black insertion stages to be the same; and
for each of the black insertion stages, determining, based on a preset second correspondence relationship between a black insertion ratio and a number of unit pulses, a target number and an adjustment direction of unit pulses that correspond to the black insertion ratio of the black insertion stage, the adjustment direction comprising increase or decrease; and increasing or decreasing, along the adjustment direction, widths of unit pulses, at the target number, on the basis of the basic pulse width in the black insertion stage, or for each of the black insertion stages, determining, based on a preset third correspondence relationship between a black insertion ratio and a basic pulse width adjustment ratio, a basic pulse width adjustment ratio and an adjustment direction that correspond to the black insertion ratio of the black insertion stage, the adjustment direction comprising increase or decrease; and
increasing or decreasing, along the adjustment direction, a width of the basic pulse width adjustment ratio of the basic pulse width on the basis of the basic pulse width.

7. The method according to claim 4, wherein the plurality of data volume ranges are in a one-to-one correspondence with a plurality of grayscale ranges, and
the display panel has a plurality of brightness levels, and under at least two of the plurality of brightness levels, the black insertion ratios corresponding to a same grayscale range are different.

8. The method according to claim 4, wherein the acquiring a target data volume for display in the display frame comprises:
determining the target data volume for display in the display frame based on a number of sub-pixels in the display panel, a grayscale displayed by each of the sub-pixels in the display frame, and a brightness level of the display panel in the display frame.

9. The method according to claim 4, wherein
the display panel has a first refresh frequency and a second refresh frequency;
a number of the plurality of data volume ranges corresponding to the first refresh frequency is n1, and a number of the plurality of data volume ranges corresponding to the second refresh frequency is n2; and
n1 and n2 satisfy: n1≠n2, where both n1 and n2 are positive integers.

10. The method according to claim 9, wherein the first refresh frequency is smaller than the second refresh frequency, and n1>n2.

11. The method according to claim 4, wherein the plurality of data volume ranges are in a one-to-one correspondence with a plurality of grayscale ranges, and the display panel has a first refresh frequency and a second refresh frequency, one of the black insertion ratios corresponding to one of the plurality of grayscale ranges at the first refresh frequency being different from another one of the black insertion ratios corresponding to the one of the plurality of grayscale ranges at the second refresh frequency.

12. The method according to claim 4, wherein the display panel has a plurality of refresh frequencies, and a number of the plurality of data volume ranges is in a range of 20 to 25 at at least one of the plurality of refresh frequencies.

13. The method according to claim 4, wherein the plurality of data volume ranges comprise a first data volume range and a second data volume range, a maximum grayscale corresponding to the first data volume range being smaller than a minimum grayscale corresponding to the second data volume range, and one of the black insertion ratios corresponding to the first data volume range being greater than one of the black insertion ratios corresponding to the second data volume range.

14. The method according to claim 4, wherein the plurality of data volume ranges comprise a first data volume range and a second data volume range, a maximum grayscale corresponding to the first data volume range being smaller than a minimum grayscale corresponding to the second data volume range, and a number of grayscales corresponding to the first data volume range being smaller than a number of grayscales corresponding to the second data volume range.

15. The method according to claim 4, wherein
numbers of grayscales corresponding to at least two of the plurality of data volume ranges are different;
the plurality of data volume ranges are the first data volume range to the n-th data volume range, a maximum grayscale corresponding to the i-th data volume range being smaller than a minimum grayscale corresponding to the (i+1)-th data volume range, where n≥3, i and (i+1) are two adjacent numbers from 1 to n, and i and n are integers; and
the numbers of grayscales respectively corresponding to the plurality of data volume ranges are in an increasing trend from the first data volume range to the n-th data volume range.

16. The method according to claim 1, wherein the black insertion ratios in the target black insertion ratios are different from each other, or the black insertion ratios in the target black insertion ratios vary linearly.

17. A method for debugging a display panel, comprising:
dividing a preset grayscale range into a plurality of grayscale ranges each comprising at least two grayscales;
acquiring a number of sub-pixels in the display panel;
acquiring a plurality of different data volume ranges based on the number of the sub-pixels in the display panel and the plurality of grayscale ranges; and
determining black insertion ratios respectively corresponding to the plurality of data volume ranges to obtain a first correspondence relationship.

18. The method according to claim 17, wherein the acquiring a plurality of different data volume ranges based on the number of the sub-pixels in the display panel and the plurality of grayscale ranges comprises:
for each of the plurality of grayscale ranges, obtaining a product of the number of the sub-pixels in the display panel and a minimum grayscale in the grayscale range as a first data volume, obtaining a product of the number of the sub-pixels in the display panel and a maximum grayscale in the grayscale range as a second data volume, and acquiring one of the plurality of data volume ranges corresponding to the grayscale range based on the first data volume and the second data volume.

19. The method according to claim 17, wherein the determining black insertion ratios corresponding to the plurality of data volume ranges to obtain a first correspondence relationship comprises:
for each of the plurality of data volume ranges, controlling the display panel to display a grayscale corresponding to the data volume range in a test frame, the test frame being divided into a plurality of test sub-frames, each of the plurality of test sub-frames comprising a black insertion stage in which the target control signal is at a non-enable level and a light-emitting stage in which the target control signal is at an enable level;
acquiring a measured brightness value for each of the plurality of test sub-frames, one of the test sub-frames of the plurality of test sub-frames being taken as a target test sub-frame;
for each of the plurality of test sub-frames other than the target test sub-frame, under a condition that a difference between the measured brightness value of the test sub-frame and a measured brightness value of the target test sub-frame is greater than a first preset threshold value, adjusting the black insertion ratio corresponding to the black insertion stage in the test sub-frame until the difference between the measured brightness value of the test sub-frame and the measured brightness value of the target test sub-frame is smaller than or equal to the first preset threshold value, to obtain an adjusted black insertion ratio corresponding to the black insertion stage in the test sub-frame; and
summarizing the adjusted black insertion ratios corresponding to the black insertion stages in the plurality of test sub-frames other than the target test sub-frame to obtain the black insertion ratios corresponding to the plurality of data volume ranges.

20. A non-transitory computer readable storage medium, storing a computer program thereon, wherein the computer program, when executed by a processor, implements steps in a method for driving a display panel that is configured to emit light under a control of a target control signal; and
the method comprises:
acquiring target black insertion ratios corresponding to a display frame,
dividing the display frame into a plurality of display sub-frames, wherein
each of the plurality of display sub-frames comprises a black insertion stage in which the target control signal is at a non-enable level and a light-emitting stage in which the target control signal is at an enable level, and
the target black insertion ratios comprises black insertion ratios that respectively correspond to the black insertion stages of the plurality of display sub-frames in the display frame, and at least two of the black insertion ratios that correspond to at least two of the black insertion stages are different from each other, and
providing the target control signal obtained based on the target black insertion ratios to the display panel.
